(19) United States
(12) Patent Application Publication
(10) Pub. No.: US 2001/0053246 A1
(43) Pub. Date: Dec. 20, 2001

(54) Color conversion system

(76) Inventors: Yoshihiro Tachibana, Chiba-ken (JP); Kozo Kitamura, Kanagawa-ken (JP)

Correspondence Address: Khanh Q. Tran, IBM Corporation C4TA/J2, 650 Harry Road, San Jose, CA, 95120, US

(21) Appl. No.: 09/725,743

(22) Filed: Nov. 29, 2000

(30) Foreign Application Priority Data
Nov. 29, 1999 (JP) 11-338827

(51) Int. Cl. G09G 5/02; G06K 9/00; G06T 11/40; G06T 11/00

(52) U.S. Cl. 382/162; 345/467

(57) ABSTRACT

The discriminability of character data that is displayed on a screen is improved by performing a color conversion on the character data. More specifically, a color conversion system is provided which comprises: extraction means for extracting character data including color data; conversion means for converting the extracted color data based on a predetermined color conversion rule; and output means for outputting the character data and the obtained color data to the application. The color conversion rule for this invention is set in advance so as to attain a specific objective (e.g., to enable a color-blind user to easily identify displayed characters). A single color conversion process and/or a process that provides the sequential conversion of multiple character colors at a constant time interval may be used.

### FIELD OF THE INVENTION

The present invention relates in general to a system for improving the visibility and discriminability of character data that are displayed on a screen, and relates specifically to a system for processing color data for such character data so as to provide improved visibility and discriminability for the character data.

### RELATED ART

Multi-tasking and multi-threading functions are included as standards in most current operating systems (OSs) in order to effectively utilize the resources provided by present day hardware. With these functions, a plurality of application programs (applications) can be executed at the same time. For example, while one, main application is being performed in the background, another application can be performed in the foreground. In addition, an environment is provided wherein a plurality of threads for an application can be running at the same time. A type of system that embodies such an environment and that can be easily understood is a windows system (a multi-windows system).

Well-known OSs of this type are Windows95, Windows98, WindowsNT, OS/2, AIX, POSIX (Portable Operating System Interface) OSs, and MacOS. Generally, an application that runs on one of these OSs must employ an API (Application Program Interface) in order to exploit the various functions that are available. One of which, the one that handles the output of data to a display unit, is a graphics display function (a video system).

Generally, an API provides a set of mathematical functions, commands and routines that are used when an application requests the execution of a low-level service that is provided by an OS. APIs differ depending on the OS types involved, and are normally incompatible. A video system is employed to handle the output provided for a display unit. By applying VGA or SVGA standards, a video system determines how data is to be displayed and then converts digital signals of display data into analog signals to transmit to a display unit. It also determines what the refresh rate and standards of a dedicated graphics processor and then converts character and color data, received from an API as digital signals of display data, into analog signals that is thereafter transmitted to a display unit. As a result, predetermined characters are displayed on a screen.

A video system has two general display modes: a graphics mode and a text mode. The text mode is an old API and is the one that is mainly supported by DOS. The graphics mode, however, is supported by other OSs such as those described above, and in that mode, data that are written in a video memory for display on a screen are handled as dot data. For example, for the graphics mode that is used to display a maximum of 16 colors, in the video memory one dot on the screen is represented by four bits (16=2⁴0). Furthermore, an assembly of color data, which collectively is called a color pallet, is used to represent colors, the qualities of which, when displayed on a screen, are determined by their red (R), green (G) and blue (B) element contents. Generally, when the color combination represented by (R, G, B)=(255, 255, 255) is used, a white dot appears on the screen. Whereas, to display a black dot on a screen, a color combination represented by (R, G, B)=(0, 0, 0) is employed (hereinafter, unless otherwise specifically defined, the color elements are represented as (R, G, B)) An OS reads the color data designated by the color pallet and the character data (character code, characters and pictures uniquely defined by a user, sign characters, special characters, symbol codes, etc.), and on a screen displays characters using predetermined colors.

As enhancements have been added to the graphics function, a greater and greater variety of colors have become available for displays. And especially on Web pages on the Internet, a large variety of colors has come to be employed, not only for the design of backgrounds, but also for the characters printed on them. However, a problem of visibility has arisen that makes it difficult for a user to identify such character data. That is, with some background and character color combinations it is almost impossible for a user to identify character data, and accordingly, the user could fail to discern important data. Furthermore, when such character data are mixed in with image data (in graphics), identifying the characters becomes even more difficult. These are serious problems, particularly for a user, such as an elderly person or a color-blind individual, whose color vision is impaired.

Persons whose color vision is impaired include, for example, those who can not identify reds (e.g., protanopia: having no red cones) and those who can not identify greens (e.g., deuteranopia: having no green cones). For these people visual accumulation of character data is practically impossible when green characters are displayed on a red background. And as for elderly persons, since as persons age clouding of the lenses of their eyes tends to occur, due, for example, to cataracts, the elderly often experience changes in their ability to sense colors, and what many of them see appears to have been passed through yellowish filters. Or, since in the lens ultraviolet ray degeneration of protein occurs, light having short wavelengths is absorbed and blue cone sensitivity is thereby reduced, and as a result, the appearance of all colors changes, yellow tending to predominate, or a blue or a bluish violet color tends to become darker. Specifically, “white and yellow,” “blue and black” and “green and blue” present discrimination problems.

As is described above, since elderly persons or others whose color vision is impaired find it extremely difficult to discriminate between characters displayed using specific colors, their reading of characters is not as efficient as that of persons whose color vision is normal. Therefore, a great load is imposed on such disabled persons when they must read or edit data using an information communication terminal. In addition, these users can not locate information on a screen that is displayed using certain colors or color combinations, and thus might not be able to read important notices. For example, when such a user employs a service provided via the Internet, such as is represented by an electronic business transaction or on-line shopping, and important information or cautionary notes are displayed using characters in specific colors that an elderly person or another individual whose ability to distinguish colors is impaired, a trade or a contract may be made that is inappropriate either for the service provider or the user, or for both.

### SUMMARY OF THE INVENTION

To resolve the above shortcomings, it is one object of the present invention to provide a system whereby a user of a computer system can easily discriminate characters used to convey information, regardless of the colors that are employed.

It is another object of the present invention to provide a system whereby elderly users or other users whose color vision is impaired can easily identify information presented using the above described characters.

It is another object of the present invention to provide a system whereby users can distinguish characters that are presented as inclusive parts of graphic screen images.

To achieve the above objects, the present invention performs color conversion processing for character data. Specifically, according to the present invention, a color conversion system comprises: (1) extraction units for extracting, from a first application, character data for which color data are included; (2) conversion units for performing a conversion of the extracted color data based on a predetermined color conversion rule; and (3) output means for outputting to the first application the character data and the obtained color data.

According to this invention, generally, the API provided by an OS is employed for the exchange of character data by extraction units and output units. When character data are included in image data, the character data may be obtained by using another program (e.g., character recognition, OCR software).

A program for obtaining character data from image data is activated when image data are selected and designated by a user (for example, when a user moves a mouse cursor and points to a screen image produced using image data). Thus, only the character data are extracted for transmission to an OS via an API.

After the color conversion of character data has been performed, the output units of this invention employs the resultant data to display characters for the first application (the main application) again. However, the output units may instead transmit the character data to a different, second application (a sub-application). Therefore, as an example, target characters may be enlarged for display by the second application, or may be output to a speech synthesis application that uses a loudspeaker to produce the sounds represented by the character data. In addition, the character data may be output to a braille translation application that uses a touch pin display unit to represent data, or to an application that supports a communication device, such as a PDA or a portable telephone.

The color conversion rule for this invention is employed to change the colors of characters so that they are suitable for a specific purpose (e.g., in order for characters to be easily discerned by a color-blind user). For this, a single color conversion process and/or a process that provides the sequential conversion of multiple character colors at a constant time interval may be used. The conversion of character data to provide colors that are suitable for a specific purpose means that a character color that can not be discriminated by a color-blind or an elderly user or a character color that even a user having normal color vision can only with difficulty distinguish because it too closely resembles a background color, is changed to a color that is easily discriminated by disabled users or a color that is easily discerned by or is emphasized for a reader, observer whose color sensing capability is not impaired.

### BRIEF DESCRIPTION OF THE DRAWINGS

FIG. 1 is a functional block diagram illustrating the overall arrangement of a color conversion system according to the present invention.

FIG. 2 is a diagram showing a specific hardware arrangement for which the present invention is applied.

FIG. 3 is a flowchart for explaining the operation performed by the present invention when the color conversion system is mounted.

FIG. 4 is a flowchart for explaining the overall processing performed by the color conversion system.

FIG. 5 is a flowchart for explaining the pre-processing performed for color conversion.

FIG. 6 is a flowchart for explaining the processing performed for color conversion.

FIG. 7 is a flowchart for explaining the processing performed by detecting the manipulation of a menu bar.

FIG. 8 is a diagram for explaining example color elements that are hard to identify.

### DESCRIPTION OF THE PREFERRED EMBODIMENTS

First, an outline explanation for the color conversion system of the present invention and for a specific embodiment will be given. Following this, explanations will be given for an embodiment wherein a speech synthesis application is employed as a sub-application, and an embodiment wherein software that is employed together to output character data in accordance with the entry of image data, such as images and image graphics.

1. A Color Conversion System and a Specific Embodiment of the Present Invention

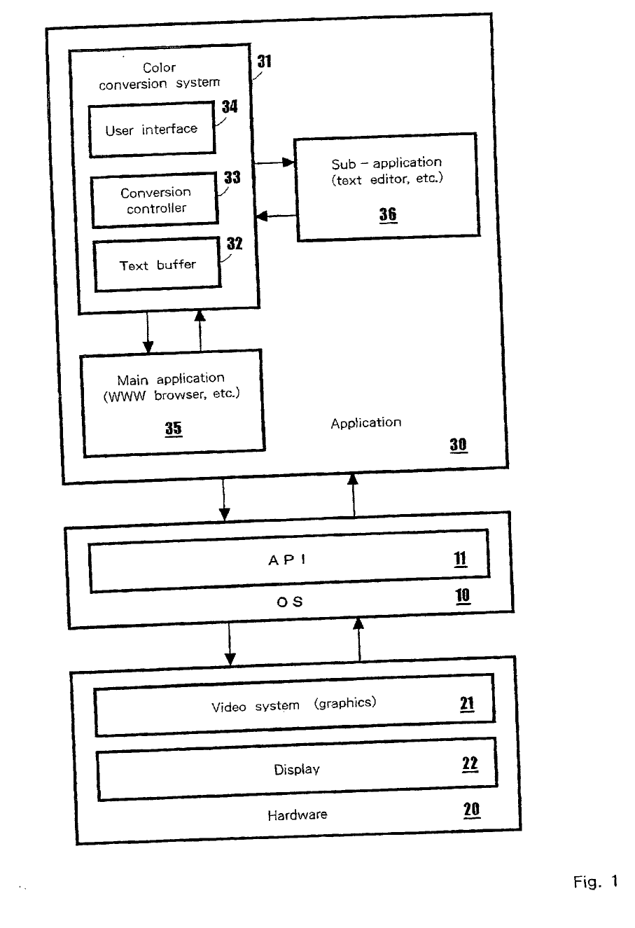

FIG. 1 is a functional block diagram illustrating the overall arrangement of a color conversion system according to the present invention, comprising mainly an OS 10, hardware 20, and an application 30. The present invention will be explained by using a system for which a main application 35 is a WWW (World Wide Web) browser, and a sub-application 36 is a Japanese editor.

The OS 10 includes an API 11 that provides a set of mathematical functions that can be used by the application 30. The API 11 has functions, such as TextOut() and ExtTextOut(), for displaying character data in a window on a display screen. These functions can designate a character data address and specify parameters for color elements (R, G, B) in a DAC (Digital To Analog Converter, also called a video DAC) having a color pallet. Thus, the character data obtained by performing a color conversion operation for data in an application can be output via a video system 21 to a display device 22.

The WWW browser 35, which is the main application, is an application for accessing or reading Web pages published on the Internet, and for exchanging E-mails. The editor 36, which is a sub-application, is an application for displaying or editing a document.

A color conversion system 31 includes: a text buffer 32 in which character data extracted by an application, such as a WWW browser, are temporarily stored; a conversion controller 33 for controlling a control parameter for color conversion and a color conversion method (algorithm); and a user interface portion 34 for controlling the input/output of a user. The color conversion system 31 extracts the character data displayed by the WWW browser, and temporarily stores the character data in the text buffer 32. The conversion controller 33 changes the color of the character data in accordance with the control parameter and a predetermined conversion method (rule). Thereafter, the resultant character data are again displayed on the main application (WWW browser) 35. In this case, the character data obtained by conversion can be output to the text editor 36, the sub-application. The user interface portion 34 manages the input and output of a user, so that the start, continuation and halting of the color conversion process, the selection of the color conversion order, and the comparison or editing of the colors for character data displayed in a window of the main application (the WWW browser) are performed in accordance with instructions received from an input/output controller, such as a menu bar for a window, a keyboard, a mouse, or a CPU-incorporated timer.

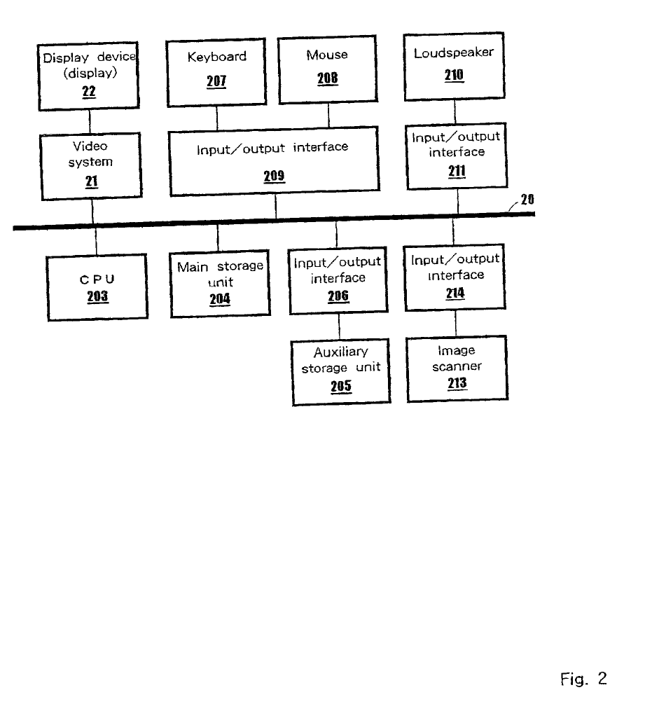

FIG. 2 is a diagram showing a specific hardware arrangement according to the present invention. A CPU 203 and a main storage unit (memory) 204 are connected to a system bus 20. A display device 22 is connected to the system bus 20 via a video system 21, and an auxiliary storage unit 205 (external storage unit, such as a hard disk) is connected to the system bus 20 via an input/output interface 206. The OS 10, the color conversion system 31, the application group 30 including the main application 35 and the sub-application 36, and other programs are stored in the auxiliary storage unit 205. A keyboard 207 and a pointing device 208, such as a mouse, are connected to an input/output interface 209 that is in turn connected to the system bus 20. When a speech synthesis application is employed as a sub-application, as will be described later, a speech output unit 210, such as a loudspeaker, can be employed that is connected to the system bus 20 via an input/output interface 211. Furthermore, when a program for extracting character data from image data is employed, as will be described later, an image reader 213, such as an image scanner, can be employed that is connected to the system bus 20 via an input/output interface 214.

When the computer system in FIG. 2 is activated, the CPU 203 reads out the OS 10 from the auxiliary storage unit 205 via the input/output interface 206, displays on the display device 22 via the video system 21, and initiates the main storage unit 204. In addition, the CPU 203 receives, via the input/interface 207, instructions that are entered using the keyboard 207 or the pointing device 208, and reads out various applications, such as the WWW browser, from the auxiliary storage unit 28 (205) and executes them.

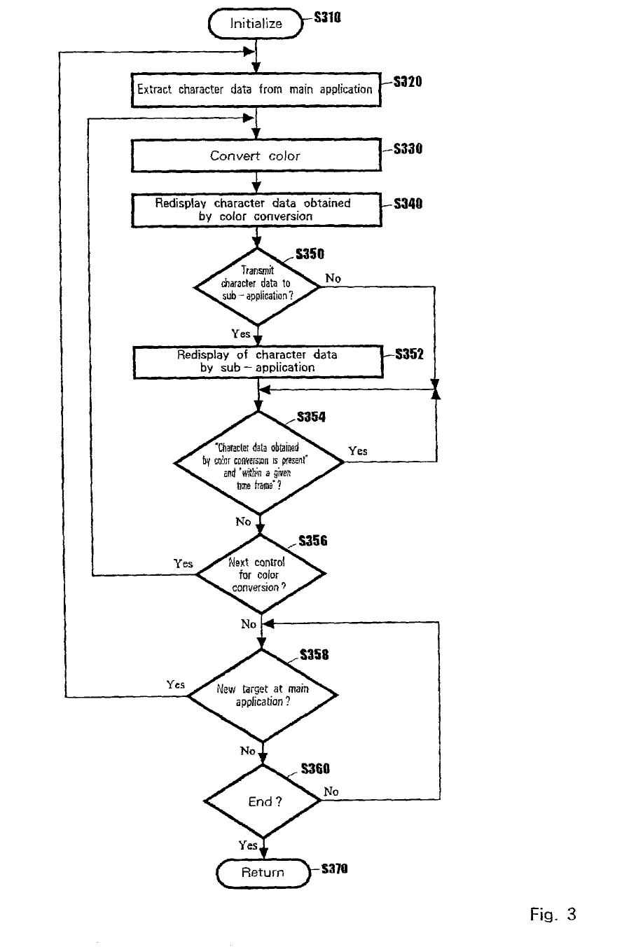

FIG. 3 is a flowchart for explaining the processing performed by the present invention shown as the color conversion system in FIG. 1. It should be noted that in the following explanation execution of the OS 10 and the WWW browser 35, which is the main application, has already been activated.

When the color conversion system 31 is activated at step S320 (hereinafter referred to simply as S320), the initialization is performed. In this process, a predetermined control parameter, which is set at the factory at the time of shipping or alternately may be set by a user, and a program wherein a color conversion method (algorithm) is described is read, and the operation of the color conversion system is determined. Other initialization processes are: (1) selection of the purpose for which the color conversion system is employed (as a convenience for a color-blind user and an elderly user; the operation, selection, editing and comparison of multitudinous colors; etc.); (2) designation of a time interval for the display of character data whose colors are changed at the following step (S354); (3) designation of application types that act as the main application 35 or the sub-application 36; (4) designation of whether, for the display screen of the main application 35, all the character data in a window, or only the character data included within a range designated by a cursor, are to be extracted; and (5) designation of image data and an application type for extracting character data from image data.

The color conversion system 31 that is activated at S320 extracts screen data displayed in a window provided by the main application 35. Specifically, the system 31 sets address data in TextOut() and ExtTextOut() functions of API to the address data of character data and sets color elements (R, G, B) of the character data by using the DAC having a color pallet and stores in a text buffer 32. The range that is to be extracted is based on data initialized at S320 (e.g., the setup is extracting all the screen data in a window). When the environment set at S320 is the extraction of only a portion of the screen data in the display screen, the position data for a cursor and the time data within the CPU are recorded.

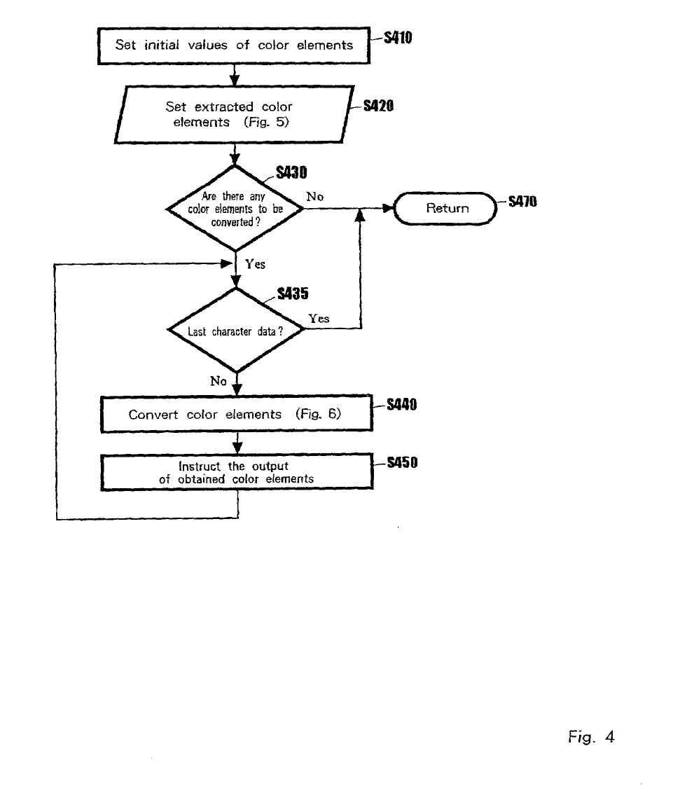

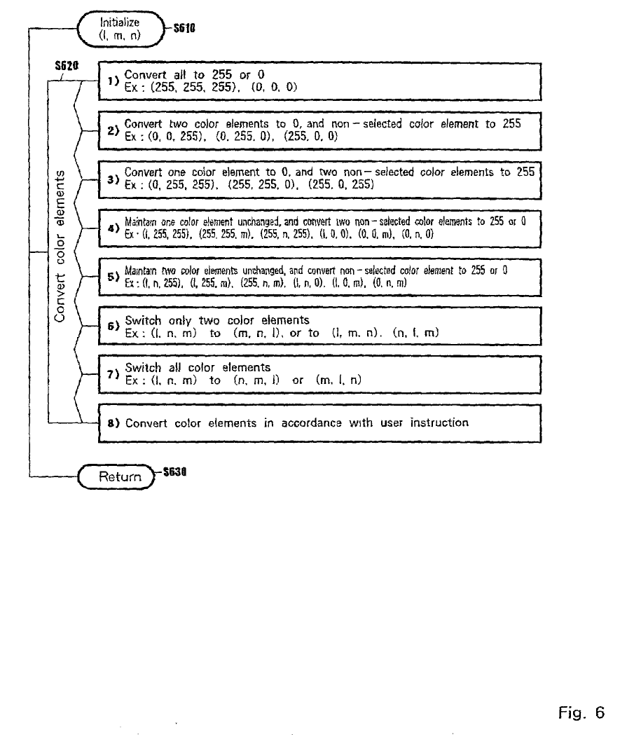

At S330, the conversion controller 33 employs the control parameter set at step S320 to change a color using a predetermined color conversion method. The control parameter for the color conversion is a parameter, as will be described later in FIG. 6, defining a rule for changing original color elements. The color conversion method for which this rule is applied will be described later, while referring to FIG. 4.

At S340, in order to output character data to the window of the main application 35, the conversion controller 33 sets in the API the address of the character data obtained by color conversion, and sets the resultant data to color elements (R, G, B) of the DAC having the color pallet. Then, when the resultant character data are output, the timer is set.

At S350, the character data obtained by color conversion are again displayed by the main application 35, and a check operation is performed to determine whether the transmission of the character data to the sub-application 36 has been designated. When it has not been designated, program control advances to a decision block at S354. When the transmission has been designated, program control goes to S352, whereat the character data are again displayed by the sub-application 36.

At S352, the transmission of the character data stored in the text buffer 32 to the sub-application 36 is designated. In this embodiment, the text editor of the sub-application 36 is so set that, for elderly users, a font that has a larger size than the one displayed by the main application is used to display the characters. Since, as is described above, the addresses of the character data have already been set in the API TextOut() function, the sub-application 36 employs these addresses when enlarging the character data by using a designated font, and then displays the data.

At S354, when character data exist that were obtained by color conversion, the elapsed time is measured by comparing the current value of the timer with the one that was set at S340. As a result, when a specific time which is defined in the environment at S320 has elapsed, program control moves to S356. While when the time has not fully elapsed, the processing is set to the standby state. And when no character data that were obtained by color conversion are available, program control advances to S356. At this time, the timer is again set to the initial value (e.g., to 0 minutes 0 seconds).

At decision step S356, a check operation is performed to determine whether the next color conversion control is to be applied. This corresponds to a case in the initial setup during which characters are set up initially to be sequentially displayed with a variety of colors. When such a control has been set, program control returns to the color conversion step S330. When such a control has not been set, program control moves to S358. While at decision step S354 a check operation is performed to determine whether or not the color conversion has been performed, and at decision step S356 a check operation is performed to determine whether the color conversion processes have been combined and whether the process has been terminated.

At S358, a check operation is performed to determine whether an instruction has been entered by the user to change the processing target on the display screen. That is, when the scrolling, the selection of a new page, the changing of a window size, or the changing of position data for a cursor is performed to the display screen through an user operation, this event is detected and program control again returns to S320 to extract display screen character data. For example, if a user moves a mouse to designate a range for color conversion, the user interface portion 34 detects it, and only character data lying within the designated range are extracted. When such an instruction has not been entered, the color conversion system 31 remains unchanged in the standby state. Thereafter, when it is detected at S360 that the user has instructed the performance of an end process for the color conversion system 31, or when a predetermined display time at the initial setup has elapsed, the processing is terminated at S370.

At S370, if the environment of the color conversion system 31 is to be changed, the environment is updated or stored, as needed, and the color conversion system 31 performs the end process. Therefore, observing from the OS 10, the color conversion system 31 is not operating or no window is displayed.

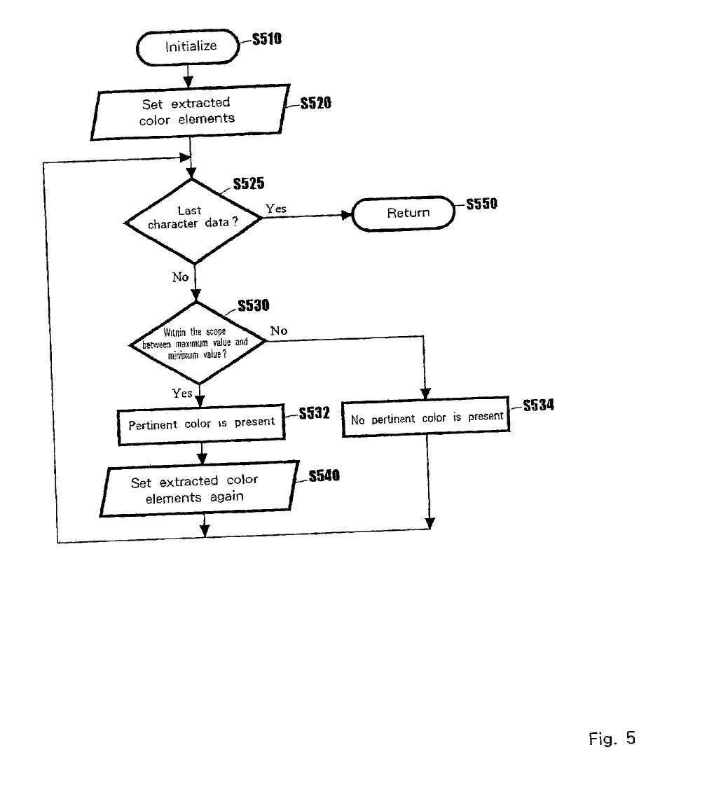

FIG. 4 is a flowchart for explaining the color conversion processing that corresponds to the process at S330 in FIG. 3. In this process, the conversion order for color elements that is used when displaying sequential color changes can be controlled. At S410, whereat an initial combination of color elements is set, black (0, 0, 0) is defined, but a different initial setup can be designated by a user. At S420, the color elements for the extracted character data are set. This is a pre-processing for specifying the target color to be converted with predetermined range, considering a variance in the display colors which depends upon the hardware characteristics of the display device to be used (e.g., CRT or TRT). Further, since the colors that elderly persons and other persons whose color vision is impaired can not identify are not always fixed, and may vary depending on each person, the process performed at S420 also function as a pre-process for color conversion while taking such a variance into account. That is, the process performed at S420 is a type of filtering process that is employed for data correction. This process will be described in detail later while referring to FIG. 5.

At S430, a check operation is performed to determine whether character data (records) that include the target color elements to be converted exist. If no character data to be converted are found, program control goes to S470 for the end process. At S435, a check operation is performed to determine whether all the character data lying within the data extraction range have been processed. If the pertinent data are not the last data, program control moves to S440. At S440, a predetermined color conversion process is performed for the character data pre-processed at S420. This color conversion process will be described later while referring to FIG. 6. At S450, a combination of converted color elements is set, and finally, an output instruction is issued to display the character data again. This color conversion step is repeated until all the extracted character data have been processed (S435).

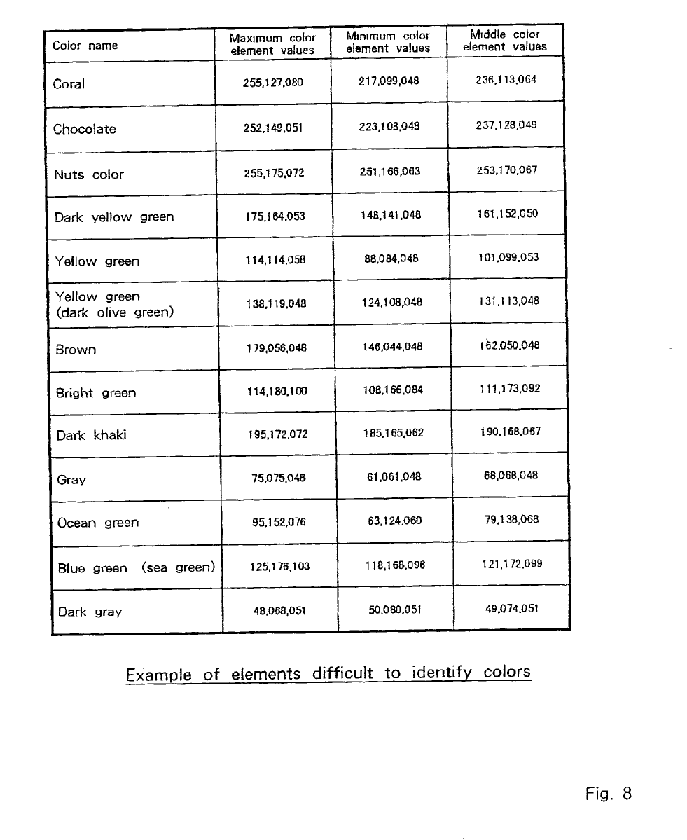

FIG. 5 is a flowchart for explaining the color conversion pre-processing performed at S420 in FIG. 4. An explanation will now be given for a case wherein the system is employed by an elderly person or another person whose color vision is impaired. The color combinations contained in Table 1 of FIG. 8 show the colors included in the character data displayed by a WWW browser, that a person whose color vision is impaired would have great difficulty in discriminating. The colors included in this table are merely examples, and all colors that are hard to be discriminated are not listed. Entered in Table 1 are the names of such colors, their maximum values, minimum values and middle values (moderate values between the maximum and the minimum) of color elements. The representative value for each color is defined as the middle value, and a range of ±25 is provided for each color element, so that the actual color variances are expressed within this range. For example, while the middle values of color elements for coral are (236, 113, 064), the color elements for the actual character data vary within a range extending from the maximum (255, 138, 089) to the minimum (211, 088, 039). This is because the variance in the displayed colors due to the characteristics of a hardware device are taken into account. To carry out the invention, as is described above, specific ranges are assigned for the color elements of the individual colors.

In the process in FIG. 5, a check operation is performed to determine whether an extracted color element combination lies within the range bounded by the maximum value and the minimum value in Table 1. If the combination falls within the range, it is defined as a pertinent designated color, and the middle value for this color is employed for resetting color elements. If the combination does not lie within the range, no resetting operation is performed. This means that the extracted color is not to be converted. The processing will now be specifically explained.

At S510, the color element data in Table 1 are initially set to a color that is determined in advance. At S520, the extracted color element data are set. At S525, a check operation is performed to determine whether all the character data lying within the designated range have been extracted. Only when the current pertinent data are the last does program control go to S550, whereat the pre-processing is terminated. At S530, the extracted color element data are compared with the color element data that were initially set at S510. When the extracted color element combination falls within the color element limits that were initially set for a color, i.e., when the extracted color lies between the minimum and the maximum values for the initially set color, wherein the middle color is also included, it is ascertained that the pertinent color that was set is present (S532). Then, at S540, the extracted color elements are again set by using the middle value of the pertinent set color. Specifically, if all the extracted color elements (R, G, B) lie within a range extending from the maximum to the minimum value of the predetermined color that was set, the pertinent color is deemed to be such predetermined color and the middle value for the color is selected. When a flag is set at this time, the presence of the pertinent color is easily detected by using the following process. The re-setup at S540 is not a requisite step, and may be performed only when a setup color is present, i.e., only when a target to be converted is present (a flag is set, etc.). When, at S530, the extracted color element combination does not lie within the range extending from the maximum to the minimum value of the setup color, it is ascertained that no pertinent color is present (S534), and program control returns to S525, whereafter, the decision steps are repeated until all the data in the designated range have been processed.

In the processing explained above in FIG. 5, a color that a user whose color vision is impaired can not easily discriminate is specified in advance as a target color to be converted, and the pre-processing required for the succeeding color conversion is performed. Therefore, this process is not required for the performance of color conversions for all the extracted character data.

FIG. 6 is a flowchart for explaining the color conversion processing to be performed at S440 in FIG. 4. In FIG. 6, values (l, n, m), which represent the elements (R, G, B), are numerical values displayed by the main application 35, or are values obtained by again setting the color elements in FIG. 5, and are represented by the natural numbers 0 to 255. At S610, the combination of color elements of character data to be converted is initially set, and at S620, the color element data are converted in accordance with a predetermined conversion rule (logic). For this example, when rule 1 is designated in advance, the color elements of all the character data to be converted are converted to either black (0, 0, 0) or white (255, 255, 255). This rule may be established during the initial setup, or may be selected by a user. While eight rules are shown in FIG. 6, no limitation is set on the number of rule types that can be used. Further, a plurality of rules can be used together to sequentially convert colors and display the obtained colors. In this case, the color conversion process is performed multiple times at S354 and S356. When the all color conversions have been performed in accordance with the predetermined rule, the processing is terminated at S630.

In FIG. 6, the conversion rules by which the color is converted into the primary color or by which the maximum luminance is set for a pertinent color (by setting the color elements to 0 or 255) are primarily used (rules 1 to 5). These rules are particularly effective for an elderly person. It should be noted, however, that a color can be set to a middle color element 127 or 128 by a user, as will be described later. According to rule 6 or 7, all or a part of the element values (l, m, n) for the individual colors are changed to convert the color.

The color conversion rules can be arbitrarily set at S620 by the user (rule 8), and a plurality of rules can be used together to sequentially convert colors and to display resultant colors. When a user likes red and yellow, he or she may choose to sequentially convert the character data colors in the order: especially dark red (64, 0, 0), dark red (128, 0, 0), bright red (255, 0, 0), yellow (255, 255, 0), and bright yellow green (128, 255, 0). In this case, five rules are designated in advance, and in accordance with these rules, steps S354 and S356 in FIG. 5 are sequentially performed to convert colors and to display the obtained colors.

For a person having impaired color vision, a rule can be set in accordance with which the order of the color elements is inverted to red, green, blue, white and black. Generally, impaired color vision is classified into one of three types: (1) protanopia and protanomaly; (2) deuteranopia and deuteranomaly; and (3) tritanopia and tritanomaly. Protanopia (no red cones) and protanomaly (abnormal red cones) are characterized in that red colors can not be identified well; deuteranopia (no green cones) and deuteranomaly (abnormal green cones) are characterized in that green colors can not be identified well; and tritanopia (no blue cones) and tritanomaly (abnormal blue cones) are characterized in that blue colors can not be identified well. Example color combinations that are extremely difficult commonly for persons whose senses of color are abnormal are: “red, green and brown,” “pink, bright blue and white (gray),” “violet, gray (black) and green,” “red, gray (black) and blue green” (see Table 1). These colors that are extremely difficult to identify are described in, for example, “A general color-blind testing chart,” Shinobu Ishihara, in the well known “Primary color vision test,” or described in “Tests and training for the congenital color-blind,” Kazuo Ichikawa, et al., The Vision Institute.

According to the above described inversion rule, a person whose color vision is only slightly impaired can identify characters. The character data are displayed by inverting colors in order of the red color elements (255, 0, 0), the green color elements (0, 255, 0), the blue color elements (0, 0, 255), the white color elements (255, 255, 255) and the black color elements (0, 0, 0). Instead of the general setup for a sequential display, a simple setup can be employed whereby only colors that can not be identified by a person whose color vision is impaired are converted into easily identified colors for display. In this case, since a plurality of rules need not be used together, multiple rules are not set, and the decision at S356 in FIG. 3 is No, so that a further color conversion process is not performed.

As is described above, an arbitrary color conversion rule can be set in advance, depending on how good the color vision of a user is. In addition, multiple rules can be employed together to sequentially display characters using different colors. Therefore, the discriminability of characters can be improved, regardless of the background color and the character color. In addition, a color conversion rule can be set whereby not only an elderly user and another user whose color vision is impaired, but also a person having normal vision can easily identify character data on a screen. Therefore, not only is it possible to avoid missing important information or cautionary notes avoided, but also the conversion rule can be employed for a character display system for providing advertising effects and a specific image.

The embodiment of this invention will now be described from the viewpoint of an user operation.

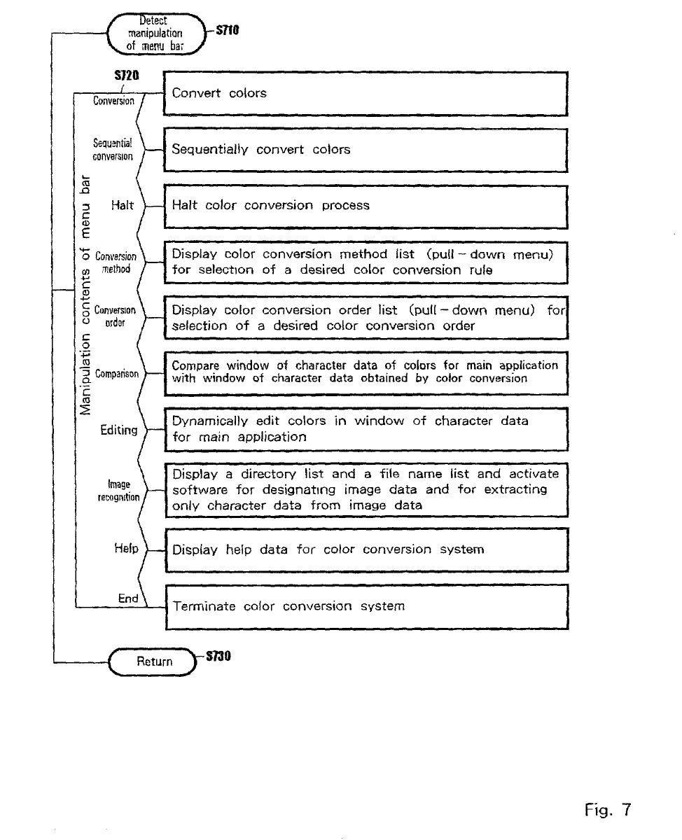

FIG. 7 is a flowchart for explaining the processing whereby the user interface portion 34, which manages requests entered by a user, detects the manipulation of a menu bar in a window. The initial value of the menu bar is set when a product is shipped from a factory, or when the color conversion system of this invention is installed, and at the first execution, nothing in particular need be designated (Null or blank). It should be noted, however, that, once the color conversion system has been activated, a value selected at this time can be stored and can be employed for the next setup.

When, at S710, the manipulation by a user of the menu bar is detected, at S720 the selected command or program is processed. In FIG. 7, the example commands are “conversion,” “sequential conversion,” “halt,” “conversion method,” “conversion order,” “comparison with preceding results,” “editing,” “image recognition,” “help” and “end.” Although it is not described, the setup “automatic conversion” may be provided to perform color conversion using a default value. For example, sequential conversion into colors that mainly an elderly person or a person having an abnormal color vision can easily identify is set as the color conversion using the default value. At S730, the command obtained from the menu bar is performed, the operation is terminated, and program control is transferred to the user interface portion 34.

The individual commands performed at S720 will now be explained. “Conversion” is a function for converting displayed character data into new colors and for again displaying the character data. Specifically, the conversion controller 33 of the color conversion system 31 performs the color conversion process. “Sequential conversion” is a function for sequentially converting the colors of character data that are displayed. In this case, character data can be sequentially displayed during a predetermined period of time; however, the time in particular may not be determined, and the character data may be sequentially displayed until the “halt” process is initiated. “Halt” is a function for halting a color conversion that is in process. This does not mean that the color conversion system 31 is deactivated (this case corresponds to the “end” that will be described later). “Conversion method” is a function for displaying a color conversion method, i.e., a list of rules (a pull-down menu), and for selecting a conversion rule. Specifically, the conversion rules in FIG. 6 are displayed and can be selected. “Conversion order” is a function for displaying a list (a pull-down menu) for the execution of orders for a color conversion rule, and for selecting the conversion rule. “Comparison with preceding results” is a function for displaying a window of character data using colors for the main application 35 (WWW browser, etc.) and a window of character data whose colors have been converted, and for comparing the two. “Editing” is a function for dynamically selecting, evaluating or editing colors in a window of character data in which colors for the main application 35 (WWW browser, etc.) are used. “Image recognition” is a function for displaying a list of names of files that include image data, and for designating the image data. By using this function, when a mouse is specifically manipulated (by double-clicking the left button, etc.) in a window prepared using image data for the main application 35 (a WWW browser), software for extracting only character data from that image data can be automatically activated. “Help” is a function for displaying the help data for the color conversion system, and “end” is a function for terminating the color conversion system.

The embodiment using the menu bar is shown in FIG. 7. However, the performance of the same functions as those described above may be effected by the specific manipulation of a keyboard (by depressing a specific function key) or a mouse (the clicking of the right button). Further, means other than a menu bar, a keyboard and a mouse, and functions other than those described above can be employed so long the manipulations required of a user can be performed easily.

2. Embodiment Using a Sub-application

The present invention has been explained as an embodiment wherein the text editor is employed as the sub-application 36. In this sub-division, an embodiment wherein a speech synthesis application is employed as a sub-application 36 will be explained while referring to FIGS. 1 and 2. The character data obtained by color conversion can be output as speech, while it is simultaneously displayed on the display for the main application 35.

In FIG. 1, the above described OS can be employed, but more preferably, it includes an API (e.g., Speech API) that enables the employment of a speech synthesis application. Since through the above color conversion the API 11 has already obtained an address for character data (e.g., the address held in TextOut()), the address is copied to the Speech API. The speech synthesis application, which constitutes the sub-application 36, employs the address copied to the Speech API to issue an instruction to the OS 10. Thus, via the input/output interface 211 (FIG. 2: e.g., a sound card available on the market) speech is produced by using the loudspeaker 210 (FIG. 2).

3. Embodiment Using Character Recognition Software

An explanation will now be given, while referring to FIGS. 1 and 2, for an embodiment of the invention wherein software for extracting character data from image data is employed as the main application 35. Image data, such as data for pictures and graphs, can be normally digitized by using an image reader, such as the image scanner 213. To copy original documents, a monochromatic scanner employs a white light beam to irradiate the documents, while a color scanner uses three color beams, red, green and blue for this purpose. Image data that are thus obtained are stored in the auxiliary storage unit 205 in a file form having an extension such as BMP, MAG, GIF, J61, JPEG, PIC, TIFF, XPM or PCX.

In this embodiment, the main application 35 is software for analyzing the digital image data and for extracting character data therefrom. The example software, in this instance, is an application that is generally called an OCR (Optical Character Recognition) program, and is representative of the programs of this type that are available on the market. The character data extracted by the OCR software 35 are temporarily stored in the text buffer 32 of the color conversion system 31 via the API 11. The conversion controller 33 then performs the previously described color conversion process, as needed, and transmits the obtained character data to the sub-application 36 (a browser, a text editor, a speech synthesis application, etc.). As a result, the character data can be displayed in a form that can easily be identified. Unlike the above embodiments, however, since the main application 35 in this embodiment is the OCR software 35, the character data are not again supplied to the main application 35. Therefore, the re-display step S340 in FIG. 3 is not required, while the re-display steps at S350 to S352, for which the sub-application is used, are required.

In this embodiment, the OCR software is employed as the main application 35; however, another software program that can extract character data from image data may be employed.

4. Other Embodiments

The present invention is not limited to the above embodiments, and can be variously modified and applied. In this specification, the WWW browser is primarily employed as the main application 35. However, other software for displaying character data, such as business application software, including word processors, spreadsheets and databases, and multimedia software, for simultaneously displaying character data and image data, may also be employed. Furthermore, other OSs 10 that can implement the object of the present invention may be used.

Another application can be used for the sub-application 36 in addition to the text editor or the speech synthesis application. For example, for a blind user, a disabled-user support application may be employed whereby character data are translated into braille, and the braille translation is output to a contact display device. The sub-application 36 may also be a communication application for supporting communication with a PDA (Personal Digital Assistant), a portable telephone or a PHS (Personal Handy-phone System) With this application, only character data included in image data can be transmitted, and the volume of the data that can be communicated is reduced. Further, although in this specification, only one type of sub-application is employed, an arrangement can be used whereby two or more sub-applications can be easily employed.

According to the color conversion system of this invention, a user of a computer system can easily identify character data, regardless of the colors used for the background and for the characters. And since the present invention can be implemented by performing a simple manipulation, it is particularly convenient for elderly persons and other persons whose color vision is impaired. In addition, not only can the invention help elderly persons and persons having impaired color vision to read remarks and cautionary notes displayed on a screen (as character data), but it can also help persons having normal color vision to read such information so that nothing important is overlooked. This helps prevent individuals from entering into illegal electronic contracts or concluding unfavorable agreements as part of on-line business transactions or during on-line shopping sessions, procedures that are becoming ever more popular as the development of information communication systems continues. Further, since the color conversion method can be set in accordance with instructions issued by users, more effective screen displays can be provided for demonstrations, seminars, education, public notices, and presentations.

Furthermore, since according to the present invention the character data can be simultaneously supplied to a sub-application, character data can be more effectively provided in accordance with the nature of a user.

Moreover, when specific types of software are employed together, character data included in image data, such as data for pictures or graphs, can be extracted and can be displayed so that it can easily be seen by a user.

1. A color conversion system comprising:
(1) extraction units for extracting, from a first application, character data for which color data are included;
(2) conversion units for performing a conversion of said extracted color data based on a predetermined color conversion rule; and
(3) output units for outputting to said first application said character data and the obtained color data.

2. The color conversion system according to claim 1, wherein said output units includes units for outputting said character data to a second application.

3. The color conversion system according to claim 1, wherein said extraction units employs said first application to extract character data from image data, and said output units outputs said character data to said second application.

4. The color conversion system according to claim 1, and further comprising: pre-processing units, for, while said extraction units extracts said character data, performing pre-processing for specifying the character data, which include color data that constitute a color conversion target for said conversion units.

5. A computer-readable recording medium on which a program for processing character data including color data, said program comprising steps of:
(1) extracting, from a first application, character data for which color data are included;
(2) performing a conversion of said extracted color data based on a predetermined color conversion rule; and
(3) outputting to said first application said character data and the obtained color data.

6. The computer-readable recording medium according to claim 5, wherein said output step includes a step of outputting said character data to a second application.

7. The computer-readable recording medium according to claim 5, wherein at said extraction step, said first application is employed to extract character data from image data, and at said output step, said character data are output to said second application.

8. The computer-readable recording medium according to claim 5, and further comprising: a pre-processing step of, in response to extraction of said extraction step, performing pre-processing for specifying the character data, which include color data that constitute a color conversion target for said conversion step.
